(19) United States
(12) Patent Application Publication
(10) Pub. No.: US 2025/0130338 A1
(43) Pub. Date: Apr. 24, 2025

(54) Method of Estimating the Speed of a Rail Vehicle and Associated Inertial Measurement Unit

(71) Applicant: Meggitt (Sensorex), Archamps (FR)

(72) Inventors: Alain Barraud, Archamps (FR); Damien Veillard, Archamps (FR)

(21) Appl. No.: 18/707,930

(22) PCT Filed: Oct. 25, 2022
(86) PCT No.: PCT/EP2022/079783

§ 371 Date: May 7, 2024

(30) Foreign Application Priority Data
Nov. 15, 2021 (FR) FR2112026

(51) Int. Cl. G01S 19/52; G01S 19/39; G01S 19/49; G01S 19/50

(52) U.S. Cl. CPC G01S 19/52; G01S 19/396; G01S 19/49; G01S 19/50

(57) ABSTRACT

The invention relates to a method for estimating the speed of a rail vehicle (100) comprising an inertial measurement unit (1) that is configured to receive GNSS signals that are associated with a satellite navigation system, comprising the following steps: —analyzing (1031) the received GNSS signals to determine the reliability of these GNSS signals; —a step of defining a measurement vector comprising the measurements taken by the initial measurement unit; —defining a state vector comprising components that are associated with the speed of the vehicle, with the attitude of the vehicle and with the bias errors in the angular velocity and acceleration measurements; —applying (1035) a state estimator to estimate the state vector using the measurement vector; —correcting the estimate of the state vector on the basis of the GNSS signals depending on the determined reliability of these GNSS signals; —extracting the speed of the rail vehicle and the error associated with the speed of the rail vehicle (100) from the corrected state vector.

The present invention relates to an inertial measurement unit and to a method for estimating the velocity of a railway vehicle combining inertial measurements and signals from a satellite navigation system.

It is important for railway-vehicle management companies to know the position and velocity of trains as accurately and reliably as possible. Specifically, knowing the exact location and velocity of trains allows traffic to be better organized and thus management of railway tracks to be improved.

Various techniques are used in the prior art to determine the velocity of railway vehicles, such as for example tachometers, Doppler radars, accelerometers, GNSS measurements (GPS signals in particular) or beacons regularly placed on the railway track—GNSS being the acronym of Global Navigation Satellite System, and GPS being the acronym of Global Positioning System. However, these various solutions all have drawbacks (wheel slip on the rails for tachometers, poor reliability in the presence of fog for Doppler radars, drift over time for accelerometers, lack of GNSS reception in tunnels and areas surrounded by steep slopes for GNSS devices, difficulty of installation and possibility of degradation for beacons) limiting the reliability of the measurements. However, the measurement reliability is a deciding factor since the safety of train passengers depends on this determination of velocity.

It is therefore necessary to provide a solution allowing a reliable estimation of the velocity of a railway vehicle to be obtained regardless of the meteorological conditions and of the topology of the railway line.

To this end, the invention relates to a method for estimating a velocity of a railway vehicle during movement of said railway vehicle along a railway track, said railway vehicle comprising an inertial measurement unit configured to deliver:
measurements of acceleration along three orthogonal axes,
measurements of angular velocities about three orthogonal axes, and to receive GNSS signals associated with a satellite navigation system, said method comprising the following steps:
a step of analyzing the received GNSS signals to determine the reliability of said GNSS signals,
a step of defining a measurement vector comprising the measurements carried out by the inertial measurement unit,
a step of defining a state vector containing components associated with the velocity of the vehicle, with the attitude and orientation (roll, pitch and yaw) of the vehicle and with bias errors in the measurements of acceleration and angular velocity,
a step of applying a state estimator to estimate the state vector using the measurement vector,
a step of correcting the estimation of the state vector based on the GNSS signals and depending on the determined reliability of said GNSS signals,
a step of extracting the velocity of the railway vehicle and the error associated with said velocity of the railway vehicle from the corrected state vector.

The use of fusion of inertial and GNSS signals when the latter are considered reliable allows a velocity of the vehicle and the error associated with this velocity to be determined.

According to another aspect of the present invention, determining the reliability of the GNSS signals comprises taking into account the number of satellites delivering signals and the position of said satellites.

According to another aspect of the present invention, the method comprises a step of correcting alignment between a reference frame associated with the inertial measurement unit and a reference frame associated with the railway vehicle.

According to another aspect of the present invention, the state vector also comprises components associated with the misalignment between the reference frame associated with the inertial measurement unit and the reference frame associated with the railway vehicle so that the misalignment is estimated recursively by the state estimator.

According to another aspect of the present invention, the method also comprises a step in which the error related to the misalignment between the reference frame associated with the inertial measurement unit and the reference frame associated with the railway vehicle is saved in a memory of the inertial measurement unit in order to be able to be used during a reset of the estimator, and in particular when the inertial measurement unit is turned on after having been turned off.

According to another aspect of the present invention, the state vector comprises 15 components, 3 components associated with the velocity of the railway vehicle, 3 components associated with the attitude of the railway vehicle, 3 components associated with the bias errors in the angular measurements, 3 components associated with the bias errors in the acceleration measurements and 3 components associated with misalignment between the reference frame associated with the inertial measurement unit and the reference frame associated with the railway vehicle.

According to another aspect of the present invention, the state estimator is a Kalman filter.

According to another aspect of the present invention, the Kalman filter is an extended Kalman filter.

According to another aspect of the present invention, the error associated with the velocity of the railway vehicle is determined based on covariances of state errors delivered by the Kalman filter.

According to another aspect of the present invention, the method comprises a static initializing step during start-up of the railway vehicle, allowing a mechanism for determining the direction of movement of the railway vehicle to be initialized during its passage from a static position to a movement position.

According to another aspect of the present invention, the step of applying a state estimator comprises applying a constraint related to a zero velocity along the transverse axes at the center of rotation of the railway vehicle.

According to another aspect of the present invention, the method comprises a validating step allowing an aberrant or non-compliant estimated velocity to be excluded.

According to another aspect of the present invention, when the GNSS signals are detected to be unreliable, the length of time for which the GNSS signals are considered to be unreliable is measured and stored in memory for a predetermined time, this length of time being used to determine the error associated with the measurement of the velocity of the railway vehicle.

According to another aspect of the present invention, the frequency at which the estimation is carried out is higher than the frequency of receipt of the GNSS signals.

The present invention also relates to an inertial measurement unit for a railway vehicle, the inertial measurement unit comprising:
an accelerometer configured to carry out measurements of acceleration along three orthogonal axes,
a gyrometer configured to carry out angular measurements about three orthogonal axes,
a module for receiving GNSS signals associated with a satellite navigation system,
a processing unit configured to:
analyze the received GNSS signals and to determine the reliability of said GNSS signals,
retrieve the measurements carried out by the accelerometer and the gyrometer,
apply a state estimator to estimate a state vector containing components associated with the velocity of the railway vehicle, with the attitude of the railway vehicle and with bias errors in the angular and acceleration measurements based on the retrieved measurements,
correct the estimation of the state vector based on the GNSS signal and depending on the determined reliability of said GNSS signal,
extract the velocity of the railway vehicle and the error associated with said velocity of the railway vehicle from the corrected state vector.

According to another aspect of the present invention, the inertial measurement unit also comprises, after the step of correcting the estimation of the state vector, a step of determining the velocity error based on covariances of errors in the states of the state estimator and on the values of the reliability of the GNSS signal over a predetermined period preceding the determining step.

Other features and advantages of the invention will become more clearly apparent on reading the following description, which is given by way of illustrative and non-limiting example, and the appended drawings, in which:

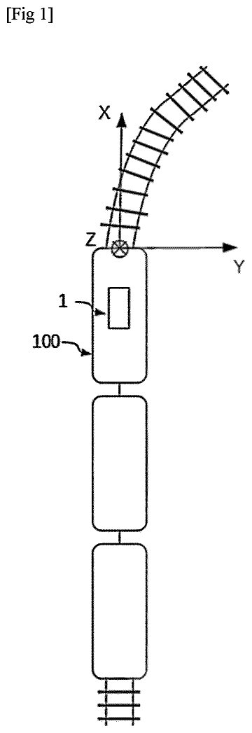

FIG. 1 shows a view from above of a railway vehicle comprising an inertial measurement unit;

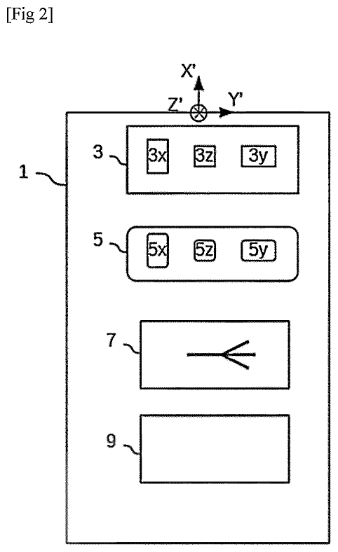

FIG. 2 shows a schematic of an inertial measurement unit according to the present invention;

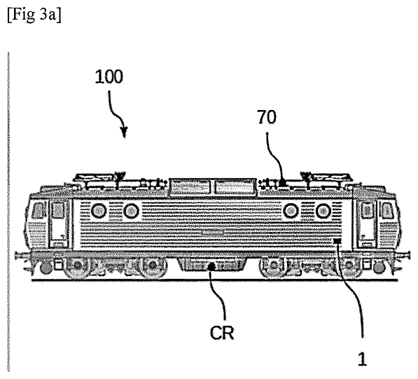

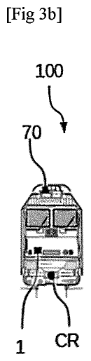

FIG. 3a shows a side view of a railway vehicle comprising an inertial measurement unit and a GNSS antenna;

FIG. 3b shows a front view of a railway vehicle comprising an inertial measurement unit and a GNSS antenna;

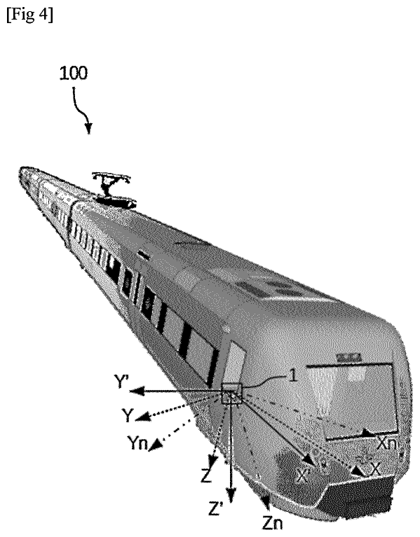

FIG. 4 shows a schematic perspective view of a railway vehicle and of the various reference frames used;

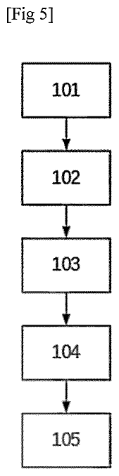

FIG. 5 shows a flowchart of the steps of a method for estimating a velocity of a railway vehicle;

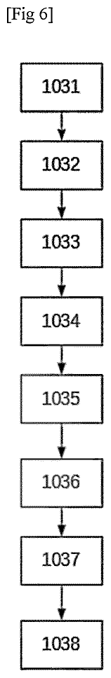

FIG. 6 shows a flowchart of the various sub-steps of application of a state estimator of the method of FIG. 5.

In these figures, identical elements have been designated with the same references.

The following embodiments are examples. Although the description refers to one or more embodiments, this does not necessarily mean that each reference relates to the same embodiment or that the features apply to a single embodiment. Individual features of various embodiments may also be combined or interchanged to provide other embodiments.

In the present description, certain elements or parameters may have been indexed, for example as first element or second element or first parameter and second parameter or first criterion and second criterion, etc. In this case, it is a question simply of indexing to differentiate and denote elements or parameters or criteria that are similar, but not identical. This indexing does not imply a priority of one element, parameter or criterion with respect to another and such denominations may easily be interchanged without departing from the scope of the present description. Nor does this indexing imply an order in time for example to assess such or such a criterion.

The present invention relates to an inertial measurement unit for a railway vehicle. By railway vehicle, what is meant here is any vehicle moving over one or more guide rails. FIG. 1 shows one example of a railway vehicle 100, for example a train comprising a locomotive and a number of wagons, two wagons in the example of FIG. 1, traveling over rails and comprising an inertial measurement unit 1 according to the present invention. However, the invention is not limited to this configuration of the railway vehicle 100 and in particular a different number of wagons may be used. However, in the context of the invention, the railway vehicle 100 concerns the locomotive comprising the inertial measurement unit 1 since the position of the wagons depends directly on the position of the locomotive. A system of axes X, Y, Z tied to the railway vehicle 100 has also been shown in FIG. 1. The X-axis corresponds to the axis of advance of the railway vehicle 100, the Z-axis corresponds to the vertical direction when the railway vehicle 100 is on horizontal rails and the Y-axis completes the system of axes and may be associated with roll, yaw and pitch axes of the railway vehicle 100.

FIG. 2 shows a schematic of the inertial measurement unit 1 according to one example of embodiment of the present invention. A system of axes X′, Y′, Z′ tied to the inertial measurement unit 1 has been shown in FIG. 2.

The inertial measurement unit 1 comprises an accelerometer 3 configured to carry out measurements of acceleration along three orthogonal axes corresponding to the three axes X′, Y′ and Z′ of the system of axes tied to the inertial measurement unit 1. The measurements are for example carried out by three accelerometers denoted 3x, 3y and 3z, which are oriented along the three axes X′, Y′ and Z′, respectively.

The inertial measurement unit 1 comprises a gyrometer 5 configured to carry out measurements of angular velocity about three orthogonal axes corresponding to the three axes X′, Y′ and Z′ of the system of axes tied to the inertial measurement unit. The measurements are for example carried out by three gyrometers denoted 5x, 5y and 5z, which are oriented along the three axes X′, Y′ and Z′, respectively.

The inertial measurement unit 1 also comprises a GNSS module 7 for receiving geolocation and navigation signals from a system of satellites associated with a satellite navigation system. In practice, the GNSS module 7 may be positioned at least in part outside the inertial measurement unit 1 and in particular the GNSS antenna 70 may be positioned in the upper part of the railway vehicle 100 to promote good reception of the GNSS signals as shown in FIGS. 3a and 3b. The GNSS antenna 70 is then connected to the GNSS module of the inertial measurement unit 1 via a wired or wireless connection.

The GNSS module 7 is thus configured to receive signals from satellites allowing the position and velocity of movement of the GNSS antenna 70 to be determined. The GNSS antenna 70 is for example configured to transmit and receive electromagnetic waves in a predetermined frequency range. The position and velocity information is for example obtained by triangulation based on signals exchanged with four satellites. The GNSS signals from the satellites are received at a first predetermined frequency, 5 Hz for example.

The inertial measurement unit 1 also comprises a processing unit 9. The processing unit 9 for example comprises a microcontroller or a microprocessor associated with a ROM or RAM.

The processing unit 9 is configured to analyze the GNSS signals received by the GNSS module 7 and to determine the reliability of said GNSS signals. The GNSS signal for example comprises the number of satellites from which a signal is received, the position of these satellites (used to determine dilution of precision or DOP) and whether multipath signals are present, which are analyzed by the processing unit 9. Depending on the results of this analysis and on the estimated reliability of the received GNSS signals, the GNSS signals will or will not be taken into account in the velocity estimation made by the inertial measurement unit 1. In addition, if GNSS signals are considered to be unreliable following analysis of the received GNSS signal, a timer is triggered to measure the length of time for which the GNSS signals are considered to be unreliable. This length of time is stored in memory for a predetermined time. The times for which the GNSS signals were considered unreliable during the predetermined time preceding the estimation are then taken into account in the estimation of an error associated with the measurement of the velocity of the railway vehicle, which will be better described in the remainder of the description.

The processing unit 9 is also configured to retrieve the measurements of acceleration and of angular velocity carried out by the accelerometer 3 and the gyrometer 5.

On the basis of the measurements delivered by the accelerometer 3 and the gyrometer 5, the processing unit 9 is configured to apply a state estimator to estimate a state vector containing components associated with the velocity of the railway vehicle 100, with the attitude of the railway vehicle 100 (i.e. its orientation, given by roll, pitch and yaw angles) and with bias errors in the angular and acceleration measurements, based on the retrieved measurements. The processing unit 9 is also configured to correct the estimation of the state vector based on the GNSS signal if the delivered GNSS signal is considered to be sufficiently reliable, in order to extract the velocity of the railway vehicle 100 and the error associated with said velocity of the railway vehicle 100 from the corrected state vector. The state vector is for example estimated using a Kalman filter and in particular an extended Kalman filter. This filtering makes it possible to fuse the measurements output by the accelerometer 3, by the gyrometer 5 and potentially by the GNSS module 7 if its reliability is sufficient. This filtering may also allow an error associated with the estimated velocity of the railway vehicle 100 to be determined from the covariances of errors in the states delivered by the Kalman filter.

The state estimator is applied recursively at a second predetermined frequency that may be greater than the first predetermined frequency, for example greater than two times the first predetermined frequency, for example 50 Hz (i.e. 10 times the first predetermined frequency).

The processing unit 9 is also configured to take into account constraints related to the movement of the railway vehicle 100 in the state estimator, such as the constraint related to a zero velocity on the transverse axes of the railway vehicle 100 at its center of rotation (denoted CR in FIGS. 3a and 3b, which show side and front views of a railway vehicle 100 comprising an inertial measurement unit 1 and a remote GNSS module 7). Taking these constraints into account thus allows the observability of the system to be increased by increasing the number of measurements, without increasing the number of sensors or in other words the cost of the device.

The processing unit 9 also comprises a self-test function that rejects aberrant values obtained by the state estimator, for example values such as a velocity greater than the maximum velocity of the railway vehicle 100, or an excessive velocity difference between two successive estimations (the maximum difference may be asymmetrical depending on maximum acceleration and braking power), or an excessive roll or pitch inconsistent with generally encountered track topologies.

The processing unit 9 is also configured to detect and correct a misalignment between the reference frame X′Y′Z′ associated with the inertial measurement unit 1 and the reference frame XYZ associated with the railway vehicle 100, so as to ensure constant self-alignment. This self-alignment is obtained by virtue of estimation, by the state estimator, of the misalignment between the reference frame X′Y′Z′ tied to the inertial measurement unit 1 and the reference frame XYZ tied to the railway vehicle 100, recursively over time. This self-alignment makes it possible to position the inertial measurement unit 1 at any location on the railway vehicle 100 and not necessarily at the center of rotation CR of the railway vehicle 100.

In addition, the processing unit 9 may be configured to save the estimated value of the misalignment between the reference frame X′Y′Z′ associated with the inertial measurement unit 1 and the reference frame XYZ associated with the railway vehicle 100 in an internal memory or a memory of the inertial measurement unit 1. This saved estimated value may be used as an initial value in case of reset of the state estimator, in particular when the inertial measurement unit 1 is turned on after having been turned off.

Thus, use of an inertial measurement unit 1 configured to fuse triaxial acceleration measurements delivered by accelerometers 3, triaxial angular-velocity measurements delivered by gyrometers 5 and GNSS data delivered by a GNSS module 7, and to estimate the reliability of the GNSS data and the misalignment between the orientation of the sensors and the orientation of the railway vehicle 100, make it possible to provide a reliable estimation of the velocity of a railway vehicle 100 and an estimation of the error associated with this velocity.

The present invention also relates to a method for estimating a velocity of a railway vehicle 100 during movement of the railway vehicle 100 along a railway track. The railway vehicle 100 is in particular equipped with an inertial measurement unit 1 such as described above.

The various steps of the method will be described with reference to the steps of the flowchart of FIG. 5. Certain of the presented steps may be optional, and the order of the steps may be different from the presented order.

The first step 101 is a preliminary initializing step carried out while static on start-up of the railway vehicle 100. This step 101 has a limited duration, for example 15 seconds, and makes it possible to initialize the sensors in order to be able to subsequently determine, in particular, the (forward or reverse) direction of movement of the railway vehicle 100.

The second step 102 is a second preliminary step of updating the various timers allowing passage of time to be monitored.

The third step 103 concerns application of the state estimator allowing the velocity of the railway vehicle 100 and the uncertainty or error associated with this velocity to be determined. This third step 103 comprises many sub-steps that will be described in detail in the remainder of the description.

The fourth step 104 concerns retrieval of the value of the misalignment between the reference frame tied to the inertial measurement unit 1 and the reference frame tied to the railway vehicle 100, which was estimated in step 103, and storage thereof in a memory, for example a flash memory. This stored value will be read when the inertial measurement unit 1 is turned on, in order to start again from the last estimation made before the inertial measurement unit 1 was turned off. This storage makes it possible to obtain a rapid convergence of the misalignment value, which may take several hours to converge in the absence of an initial value, and allows an accurate velocity estimation to be obtained as soon as the inertial measurement unit 1 is turned on.

The fifth step 105 concerns delivery of output data and in particular the velocity of the railway vehicle 100 and the associated uncertainty estimated in step 103. Depending on the needs of the customer, other data estimated in step 103 may also be extracted and delivered. Delivery for example corresponds to the transmission of a data signal to the cockpit of the railway vehicle 100.

The details of step 103 will now be described in detail with reference to the flowchart of FIG. 6.

The first sub-step 1031 concerns analysis of the GNSS signal received by the GNSS module 7, in order to determine whether the reliability of the GNSS signal is sufficient for it to be taken into account in determining the velocity of the railway vehicle 100. This analysis takes into account the number of satellites from which signals are received, the position of the satellites from which signals are received (used to determine dilution of precision or DOP) or the fact that the received signal has been reflected, in particular from the terrain around the railway vehicle 100 (multipath). All these parameters are taken into account to determine the reliability of the delivered GNSS signal. This determined reliability may be compared to a predetermined threshold. If the determined reliability is less than the predetermined threshold, the GNSS signal is not taken into account in the estimation of the velocity of the railway vehicle 100 and only the measurements of the accelerometers and gyrometers are then used. If the determined reliability is greater than the predetermined threshold, the GNSS signal is taken into account, i.e. it is fused with the measurements of the accelerometers 3 and of the gyrometers 5 in the estimation of the velocity of the railway vehicle 100. The GNSS signals allow the velocity of the railway vehicle 100 and an error in this velocity to be estimated.

The second sub-step 1032 concerns analysis of the movement and vibrations of the railway vehicle 100, by means of the accelerometers 3 and gyrometers 5, to determine whether the railway vehicle 100 is stationary or in motion and the (forward or reverse) direction of movement of the railway vehicle 100. This in particular makes it possible to stop the estimation when the railway vehicle 100 is stationary and no GNSS signal is being received, for example in the case of stoppage at an underground station. Stopping the estimation in these cases makes it possible to avoid state-estimator instability that could lead to erroneous estimations.

The third sub-step 1033 concerns measurement of the length(s) of time for which the GNSS signal is unreliable. The length(s) of time for which the GNSS signal is deemed unreliable for a predetermined time interval are stored in memory and used to compute the uncertainty associated with the velocity of the railway vehicle 100. The predetermined time interval for example corresponds to a few minutes or tens of minutes. Specifically, when the GNSS signal is not taken into account, the velocity estimation is carried out only based on the inertial measurements, i.e. the measurements of the accelerometers 3 and gyrometers 5, and hence the uncertainty associated with the estimation of the velocity of the railway vehicle 100 increases over time, until the GNSS signal is again reliable. Should the GNSS signal alternate between being deemed reliable and unreliable, it is necessary to know the history of the reliability of the GNSS signal over the course of preceding moments or even minutes in order to be able to take into account these GNSS-signal instabilities in the computation of the uncertainty in the velocity of the railway vehicle 100.

The fourth sub-step 1034 concerns detection of an anomaly during computation of the state estimator, for example corresponding to saturation or malfunction of the processing unit 9. In case of detection of an anomaly, the estimator will be reset the next time the railway vehicle 100 is detected to have stopped in sub-step 1032.

The fifth sub-step 1035 concerns update of the state estimator based on the last measurements and possibly on the GNSS signal if its reliability is sufficient.

To do this, a state vector E with 15 components is defined:

$$E = {[ {V}_{x}^{t} \vert {V}_{y}^{t} \vert {V}_{z}^{t} \vert ϕ \vert θ \vert ψ \vert {b}_{g x} \vert {b}_{g y} \vert {b}_{g z} \vert {b}_{a x} \vert {b}_{a y} \vert {b}_{a z} \vert α \vert β \vert Θ ]}^{T}$$

with Vₓ^{t} the velocity along the X-axis, V_{y}^{t} the velocity along the Y-axis, V_{z}^{t} the velocity along the Z-axis, ϕ the roll angle between the reference frame tied to the railway vehicle 100 and the navigation reference frame, θ the pitch angle between the reference frame tied to the railway vehicle 100 and the navigation reference frame, ψ the yaw angle between the reference frame tied to the railway vehicle 100 and the navigation reference frame, box the X′-axis bias of the gyrometer 5, b_{gy} the Y′-axis bias of the gyrometer 5, b_{gz} the Z′-axis bias of the gyrometer 5, α a latitude pseudo-coordinate of the axis of the misalignment between the reference frame X′Y′Z′ tied to the inertial measurement unit and the reference frame XYZ tied to the railway vehicle 100 (use of a pseudo quaternion formalism), β a longitude pseudo-coordinate of the axis of the misalignment between the reference frame X′Y′Z′ tied to the inertial measurement unit 1 and the reference frame XYZ tied to the railway vehicle 100 (use of a pseudo quaternion formalism) and O the angle of the misalignment between the reference frame X′Y′Z′ tied to the inertial measurement unit 1 and the reference frame XYZ tied to the railway vehicle 100.

An observation vector O with five components is also defined:

$$O = {[ {V}_{x}^{n} \vert {V}_{y}^{n} \vert {V}_{z}^{n} \vert {V}_{y}^{t} \vert {V}_{z}^{t} ]}^{T}$$

with Vₓⁿ the velocity measurement delivered by the GNSS module 7 along the Xn-axis of the navigation reference frame (the origin of which corresponds to the location of the antenna 70 of the GNSS module 7), V_{y}ⁿ the velocity measurement delivered by the GNSS module 7 along the Yn-axis of the navigation reference frame (the origin of which corresponds to the location of the antenna 70 of the GNSS module 7), V_{z}ⁿ the velocity measurement delivered by the GNSS module 7 along the Zn-axis of the navigation reference frame (the origin of which corresponds to the location of the antenna 70 of the GNSS module), V_{y}^{t} the velocity measurement along the Y-axis of the reference frame tied to the railway vehicle 100 and V_{z}^{t} the velocity measurement along the Z-axis of the reference frame tied to the railway vehicle 100 (the origin of which is at the center of rotation CR of the railway vehicle 100).

The prediction at time k+1 is defined by:

$$O ( k + 1 ) = f ( O ( k ) )$$

with f the nonlinear prediction model defined by:

$${O}_{1 : 15} ( k + 1 ) = \{ \begin{matrix}{\dot{V}}^{t} ( k ) * dt + {O}_{1 : 3} ( k ) , \\ a tan ( \frac{{\hat{R}}_{{t}_{3 : 3}}^{n} ( k )}{{\hat{R}}_{{t}_{3 : 1}}^{n} ( k )} ) , \\ - asin ( {\hat{R}}_{{t}_{3 : 1}}^{n} ( k ) ) , \\ a tan 2 ( \frac{{\hat{R}}_{{t}_{2 : 1}}^{n} ( k )}{{\hat{R}}_{{t}_{1 : 1}}^{n} ( k )} ) , \\ {O}_{7 : 15} ( k )\end{matrix} ,$$

V^{t} being the velocity-variation vector of the railway vehicle 100, expressed in the reference frame XYZ tied to the railway vehicle 100, dt the sampling time, Rₜⁿ the rotation matrix between the reference frame XYZ tied to the railway vehicle 100 and the navigation reference frame XnYnZn, and \hat{R}ₜⁿ the prediction of the rotation matrix between the reference frame XYZ tied to the railway vehicle 100 and the navigation reference frame XnYnZn as a function of ω_{nb}^{t} and defined by:

$${\hat{R}}_{t}^{n} = {R}_{t}^{n} ( k ) * ( {I}_{3} + S [ {ω}_{n b}^{t} ( k ) * d t ] )$$

with I₃ an identity matrix of 3*3 size, S[x] the antisymmetric form of the vector x and ω_{nb}^{t} the vector of the angular velocities of the navigation reference frame XnYnZn with respect to the reference frame X′Y′Z′ tied to the inertial measurement unit 1, expressed in the reference frame XYZ tied to the railway vehicle 100, i.e. the angular velocities associated with the movement of the railway vehicle 100.

The following relationship is then defined:

$${ω}_{n b}^{t} ( k ) = {ω}_{i b}^{t} ( k ) - {ω}_{i e}^{t} ( k ) - {ω}_{e n}^{t} ( k )$$

with ω_{ib}^{t} the vector of the angular velocities of the inertial reference frame XiYiZi (described below) with respect to X′Y′Z′ tied to the inertial measurement unit 100, ωᵢₑ^{t} the vector of the angular velocities of the inertial reference frame XiYiZi with respect to the terrestrial reference frame XtYtZt (described below), expressed in the reference frame XYZ tied to the railway vehicle 100, i.e. the velocity of rotation of the Earth, and wen the vector of the angular velocities of the terrestrial reference frame with respect to the navigation reference frame XnYnZn, expressed in the reference frame XYZ tied to the railway vehicle 100, i.e. the velocity of rotation associated with the curvature of the Earth.

The inertial reference frame XiYiZi corresponds to an absolute reference frame the origin of which is the center of the Earth and that does not follow the rotation of the Earth. Its axes point to stars far enough way to seem fixed with respect to the center of the Earth. The axis Xi points toward the vernal equinox, the axis Zi is parallel to the axis of rotation of the Earth and the axis Yi is orthogonal to Xi and Zi to complete the system of axes XiYiZi. It is necessary to use the inertial reference frame because the rotation of the Earth (with respect to the inertial reference frame) is measured by the gyrometers 5 and must therefore be taken into account for estimating the velocity of the railway vehicle 100.

The terrestrial reference frame XtYtZt has its origin at the center of the Earth, the axis Zt is parallel to the axis of rotation of the Earth, the axis Xt points toward the Greenwich meridian (longitude=0) and the axis Yt is orthogonal to Xt and Zt to complete the system of axes XtYtZt.

The measurements of the gyrometers 5 may be defined by:

$${ω}_{i b}^{t} ( k ) = {R}_{b}^{t} ( k ) * {Meas}_{gyro} ( k ) - {X}_{7 : 9} ( k )$$

with R_{b}^{t}(k) the rotation matrix between the reference frame X′Y′Z′ tied to the inertial measurement unit and the reference frame XYZ tied to the railway vehicle 100 and Meas_{gyro} the vector of the measurements of the gyrometers 5 in the reference frame X′Y′Z′ tied to the inertial measurement unit 1.

\dot{V}^{t} it is then defined by the following relationship:

$${\dot{V}}^{t} = {f}^{t} ( k ) - {f}_{c}^{t} ( k ) - {f}_{g}^{t} ( k )$$

with f^{t} the vector of the specific force measured by the accelerometers 3, expressed in the reference frame XYZ tied to the railway vehicle, f_{c}^{t} the vector of the Coriolis force, expressed in the reference frame XYZ tied to the railway vehicle 100 and f_{g}^{t} the vector of the gravitational force, expressed in the reference frame XYZ tied to the railway vehicle 100.

The measurements of the accelerometers 3 may be defined by:

$${f}^{t} ( k ) = {R}_{b}^{t} ( k ) * {Meas}_{a c c} ( k ) - {X}_{10 : 12} ( k )$$

with Meas_{acc} the vector of the measurements of the accelerometers 3 in the reference frame XYZ tied to the railway vehicle 100.

In order to establish a relationship between the estimated state parameters and the observational measurements carried out by the GNSS module 7 and the velocities associated with the center of rotation CR of the railway vehicle 100, a correction model h used in the Kalman filter is defined, which model allows the velocities estimated by the Kalman filter for the following time to be transformed (i.e. reference frame changed) and transposed (i.e. origin changed) and compared with the velocities measured at this following time.

$$Y ( k ) = h ( X ( k ) )$$

The correction model h is a nonlinear model defined by:

$${Y}_{1 : 5} ( k ) = \{ \begin{matrix}{R}_{t}^{n} ( k ) * ( {X}_{1 : 3} ( k ) + S [ {ω}_{nb}^{t} ( k ) ] * {L}_{imu 2 gnss} \\ {X}_{2} ( k ) + {S}_{2 :} [ {ω}_{nb}^{t} ( k ) ] * {L}_{imu 2 rot} \\ {X}_{3} ( k ) + {S}_{3 :} [ {ω}_{nb}^{t} ( k ) ] * {L}_{imu 2 rot}\end{matrix}$$

with Rₜⁿ the rotation matrix between the reference frame XYZ tied to the railway vehicle 100 and the navigation reference frame XnYnZn, S[x] the antisymmetric form of the vector x and ω_{nb}^{t} the vector of the angular velocities of the navigation reference frame XnYnZn with respect to the reference frame X′Y′Z′ tied to the inertial measurement unit 1, expressed in the reference frame XYZ tied to the railway vehicle 100, i.e. the angular velocities associated with the movement of the railway vehicle 100.

Thus, the update of the state estimator comprises a predicting phase in which the states of the system (velocity of the railway vehicle 100 in particular) and the associated uncertainties are predicted based on inertial measurements, i.e. measurements of the accelerometers 3 and gyrometers 5, then a correcting phase in which the estimation of the states of the system is corrected by means of a correction model based on equations associated with the railway application and on data delivered by the GNSS module 7.

The sixth sub-step 1036 concerns evaluation of a confidence interval of the velocity estimation carried out in sub-step 1035.

The purpose of this evaluation is to ensure that the estimated velocity associated with its confidence interval meets the performance and safety criteria set by railway standards, for example that the error between the actual velocity and estimated velocity is comprised in the confidence interval 99.99% of the time or that the confidence interval is less than a value set by railway standards 99.9% of the time.

This confidence interval may be defined based on the uncertainty estimated by the Kalman filter. Alternatively, this confidence interval may be determined empirically based on a high number of measurements carried out in various configurations. A curve, for example a polynomial, may be obtained by means of a polynomial regression applied to all the measurements. In addition, in both cases, weighting coefficients may be applied depending on certain criteria such as whether misalignment convergence has been obtained at the time of estimation or not.

According to one particular embodiment, the determining method uses the value estimated by the Kalman filter under certain conditions, for example when the signals delivered by the GNSS module 7 are reliable, and an empirically obtained value when the signals delivered by the GNSS module 7 are unreliable. Weighting coefficients may also be applied in this embodiment.

The seventh sub-step 1037 concerns validation of the estimations (states (including velocity), uncertainties, velocity confidence interval). To this end, various tests are carried out. The estimated dynamics are for example compared with the theoretical dynamics of a railway vehicle 100. The estimations of the errors of the sensors (accelerometers 3 and gyrometers 5) may also be compared to known sensor uncertainties.

The eighth sub-step 1038 concerns update of the estimated misalignment between the reference frame X′Y′Z′ tied to the inertial measurement unit 1 and the reference frame XYZ tied to the railway vehicle 100 and computation of its uncertainty.

Thus, use of an inertial measurement unit 1 delivering three-dimensional measurements of accelerations and angular velocities coupled with a GNSS module and use of an estimator allowing the measurements delivered by the inertial sensors and the GNSS module 7 to be fused when the GNSS signal is reliable enough makes it possible to obtain an estimation of the velocity of a railway vehicle 100 and of the error associated with this estimated velocity. In addition, determining a confidence interval associated with the velocity estimation ensures that the measurement made meets railway standards. Lastly, determining a misalignment between the reference frame tied to the inertial measurement unit 1 and the reference frame tied to the railway vehicle 100 makes it possible to position the inertial measurement unit 1 in any location on the railway vehicle 100.

1. A method for estimating a velocity of a railway vehicle during movement of said railway vehicle along a railway track, said railway vehicle comprising an inertial measurement unit configured to deliver:
measurements of acceleration along three orthogonal axes,
measurements of angular velocities about three orthogonal axes,
and to receive GNSS signals associated with a satellite navigation system, said method comprising the following steps:
a step of analyzing received GNSS signals to determine a reliability of said GNSS signals,
a step of defining a measurement vector comprising the measurements carried out by the inertial measurement unit,
a step of defining a state vector containing components associated with the velocity of the railway vehicle, with an attitude of the railway vehicle and with bias errors in the measurements of acceleration and angular velocity,
a step of applying a state estimator to estimate the state vector using the measurement vector,
a step of correcting an estimation of the state vector based on the GNSS signals and depending on determined reliability of said GNSS signals,
a step of extracting the velocity of the railway vehicle and an error associated with said velocity of the railway vehicle from a corrected state vector.

2. The method of claim 1, wherein determining the reliability of the GNSS signals comprises taking into account a number of satellites delivering signals and a position of said satellites.

3. The method of claim 1, wherein the method comprises a step of correcting alignment between a reference frame (X′Y′Z′) associated with the inertial measurement unit and a reference frame (XYZ) associated with the railway vehicle.

4. The method of claim 3, wherein the state vector also comprises components associated with a misalignment between the reference frame (X′Y′Z′) associated with the inertial measurement unit and the reference frame (XYZ) associated with the railway vehicle so that the misalignment is estimated recursively by the state estimator.

5. The method of claim 4, further comprising a step in which an error related to the misalignment between the reference frame (X′Y′Z′) associated with the inertial measurement unit and the reference frame (XYZ) associated with the railway vehicle is saved in a memory of the inertial measurement unit in order to be able to be used during a reset of the state estimator.

6. The method of claim 1, wherein the state vector comprises 15 components, 3 components associated with the velocity of the railway vehicle, 3 components associated with the attitude of the railway vehicle, 3 components associated with the bias errors in angular measurements, 3 components associated with the bias errors in acceleration measurements and 3 components associated with misalignment between a reference frame associated with the inertial measurement unit and a reference frame associated with the railway vehicle.

7. The method of claim 1, wherein the state estimator is a Kalman filter.

8. The method of claim 7, wherein the Kalman filter is an extended Kalman filter.

9. The method of claim 7, wherein the error associated with the velocity of the railway vehicle is determined from covariances delivered by the Kalman filter.

10. The method of claim 1, wherein the method comprises a static initializing step during start-up of the railway vehicle, allowing a mechanism for determining a direction of movement of the railway vehicle to be initialized during its passage from a static position to a movement position.

11. The method of claim 1, wherein the step of applying a state estimator comprises applying a constraint related to a zero velocity along transverse axes at a center of rotation of the railway vehicle.

12. The method of claim 1, wherein the method comprises a validating step allowing an aberrant or non-compliant estimated velocity to be excluded.

13. The method of claim 1, wherein, when the GNSS signals are detected to be unreliable, a length of time for which the GNSS signals are considered to be unreliable is measured and stored in memory for a predetermined time, the length of time being used to determine the error associated with a measurement of the velocity of the railway vehicle.

14. The method of claim 1, wherein a frequency at which the estimation is carried out is higher than a frequency of receipt of the GNSS signals.

15. An inertial measurement unit for a railway vehicle, the inertial measurement unit comprising:
an accelerometer configured to carry out measurements of acceleration along three orthogonal axes,
a gyrometer configured to carry out angular measurements about three orthogonal axes,
a module for receiving GNSS signals associated with a satellite navigation system,
a processing unit configured to:
analyze received GNSS signals and to determine a reliability of said GNSS signals,
retrieve the measurements carried out by the accelerometer and the gyrometer,
apply a state estimator to estimate a state vector containing components associated with a velocity of the railway vehicle, with an attitude of the railway vehicle and with bias errors in the angular measurements and acceleration measurements based on retrieved measurements,
correct an estimation of the state vector based on the GNSS signals and depending on determined reliability of said GNSS signals,
extract the velocity of the railway vehicle and an error associated with said velocity of the railway vehicle from a corrected state vector.

16. The inertial measurement unit of claim 15, further comprising, after the step of correcting the estimation of the state vector, a step of determining a velocity error based on covariances of errors in states of the state estimator and on values of the reliability of the GNSS signals over a predetermined period preceding the step of determining the velocity error.
